(19) United States
(12) Patent Application Publication
(10) Pub. No.: US 2004/0054636 A1
(43) Pub. Date: Mar. 18, 2004

(54) Self-organizing neural mapper

(75) Inventor: Richard Tango-Lowy, Litchfield, NH (US)

Correspondence Address: BOURQUE & ASSOCIATES, P.A., 835 HANOVER STREET, SUITE 303, MANCHESTER, NH, 03104, US

(73) Assignee: Cognita, Inc.

(21) Appl. No.: 10/621,109

(22) Filed: Jul. 16, 2003

Related U.S. Application Data
(60) Provisional application No. 60/396,109, filed on Jul. 16, 2002.

(51) Int. Cl. G06F 17/00; G06N 5/02; G06F 15/18; G06E 3/00; G06N 3/02; G06E 1/00; G06G 7/00

(52) U.S. Cl. 706/16; 706/15; 706/46

(57) ABSTRACT

A system and method for acquiring and easily locating knowledge, effectively “memorizes” and “recalls” knowledge by dynamically relating similar concepts and ideas. Concepts and ideas are considered “similar” when they successfully answer similar questions or solve similar problems, as specified by the person or agent doing the searching. The invention is independent of the physical database and logic implementation, and is also independent of the user interface used to memorize (learn) new knowledge or recall (search for) existing knowledge.

### CROSS-REFERENCE TO RELATED APPLICATIONS

This application claims benefit of U.S. Provisional Patent Application No. 60/396,109.

### TECHNICAL FIELD

This invention relates to knowledge management and more particularly, to artificial learning as applied to the creation, representation, and subsequent retrieval of information within a singular or distributed knowledge database.

### BACKGROUND INFORMATION

The purpose of this invention, and knowledge management in general, is to help provide relevant solutions to questions and problems that have been solved before. An encyclopedia is, for example, a primitive knowledge management system: it provides a simple way for people to find information. In the case of the encyclopedia, the information is prepared, categorized, and cross-indexed to help people find the information more effectively.

While the information in an encyclopedia is static, computers allow us to collect and store large amounts of rapidly-changing information. So much information, in fact, that the ability to locate relevant answers becomes a critical, but challenging problem. Companies and organizations face a similar challenge in trying to provide employees, business partners, and customers with information about products and processes. Web sites and email are often used to communicate dynamic information, but can't provide a single point of access and have only increased the information-access challenge.

Prior and existing attempts to solve this problem have resulted in two basic approaches to knowledge management: the user-burdened approach and the provider-burdened approach.

Applications implementing the user-burdened approach depend on highly-automated systems to gather, categorize, and present information in a format that puts the burden of the work on the person doing the searching. The user generally enters keywords using a specific syntax that often requires quotes or boolean symbols, such as “AND” and “OR,” and is presented with a list of possible results. The user must then modify their search to narrow the list, requiring that the user understand how to best present and improve their search criteria. This type of knowledge system will always return the same results for a search unless something is added or removed from the knowledge database. Most web search engines are “user-burdened” systems.

The provider-burdened approach makes use of a human content management team, possibly assisted by some automated categorization technology, to manually organize the information to make it easier to find. This categorization process is time-consuming and resource-intensive, resulting in a system that is easier for users to search than user-burdened systems, but much more expensive to maintain.

A common problem with provider-burdened systems, is that it is difficult and expensive to keep knowledge up-to-date. Technologies in this category range from case-based reasoning (CBR) tools (reference to Inference patent) to most cognitive processing tools (see U.S. Pat. No. 5,797,135 Whalen et al.). This type of knowledge system is most frequently implemented by large companies and corporations, that can afford the cost and manpower required to create and maintain the content.

Neither of these approaches is satisfactory on its own. One is difficult to use and the other is costly to maintain. There are currently few, if any, knowledge solutions that are both easy to search and cost-effective to maintain. Most existing technologies focus on identifying implied meaning by organizing the content or applying decision tree or other lexical technologies to the questions submitted. They try to match a search to an answer based upon the terms or the meanings found in the answer itself.

### SUMMARY

The impetus to the Self-Organizing Neural Mapper (SONM) technology according to the present invention is a result of study and use of many of the prior art technologies, and the less-then successful attempts of most organizations and companies to implement them. The concept of SONM itself is based upon the works of computer pioneer Alan Turing in machine intelligence and of linguist and scientist Marvin Minsky in human learning, as well as upon the inventor's own studies in linguistics and human communication. The goal was to develop an engine that would remove the burden from both the user and provider by learning how to provide answers based upon how previous questions were asked.

The benefits of the present invention are a system that is: Easy to create. Those with knowledge to share need only concern themselves with the actual content, rather than its structure and formatting. Easy to maintain. No expensive knowledge engineers are required to prepare, categorize, and organize content or build fancy decision trees. Easy to search. users can ask questions in the way the makes the most sense to them, without resorting to quote marks or confusing boolean logic. Reusable. If one person has a question, it's likely others will have the same question. The more an answer is used, the easier it becomes to find. Self-Improving. The present invention leverages user feedback and behavior to strengthen or weaken the association between a specific answer and the original question.

The net benefit of the present invention is a technology that is extremely inexpensive to implement and use, and that becomes more useful as people use it to create, access, and apply information.

### BRIEF DESCRIPTION OF THE DRAWINGS

These and other features and advantages of the present invention will be better understood by reading the following detailed description, taken together with the drawings wherein:

FIG. 1 is a block diagram of the present invention;

FIG. 2 is an object class diagram that illustrates the objects and relationships necessary to implement a system and method according to the present invention;

FIG. 3 shows the steps required to create a new answer in the database;

FIG. 4 shows the steps required when searching for an answer;

FIG. 5 shows the steps required to learn from the search;

FIG. 6 shows how a new piece of content, or memory, is added to the knowledge database including neurons and strengths;

FIG. 7 shows what a memory looks like in the database with other memories.

FIG. 8 shows how a search, or query, finds and prioritizes answers; and

FIG. 9. shows how memories are strengthened and weakened after the system receives feedback from the user.

### DETAILED DESCRIPTION OF THE PREFERRED EMBODIMENTS

Implementation of the present invention 10, FIG. 1, requires a minimum of a relational database engine 12 and a small program to implement the logic 14 for the Teaching Engine 14, the Searching Engine 16 and the Learning Engine 18. The relational database engine, or RDBMS 12, can be one of any number of commercial or free offerings, or can be developed as part of the application logic 14 itself. The implementation logic 14 can be written using any appropriate programming language, can be implemented in hardware, or can be implemented using RDBMS structures such as stored procedures and triggers.

The Teaching Engine 14 database schema consists of three related tables with the following specifications:

The Answer Table 20 contains summaries and answers; the actual knowledge in the database or a pointer to where it can be found, and includes the following fields:

Field: Id: Unique identifier for each answer.

Field: Summary: Brief description of the answer or question being answered.

Field: Detail: The full answer. This can be in any format, although it will typically be implemented in HTML, XML or SGML.

The Symbol Table 22 contains the unique symbols used by the search engine to match a query with an answer and includes the following field:

Field: Name (a text string or a link to an external multimedia object, such as an image or sound).

The Neuron Table 24 contains the neuron objects that link specific symbols with specific answers, and include the following fields:

Field: Id: Link to the ID field in the Answer table.

Field: Name: Link to the Symbol field in the Symbol table.

Field: Strength: Weight of this neuron.

The Searching Engine database schema 16 typically includes three related tables with the following specifications:

The Query Table 26 contains a list of user queries. For every new search, an entry is created in the Query Table, and remains until the query is resolved. The Query table includes the following field:

Field: Id: Unique identifier for each attempted search.

The Stimulus Table 28 contains the stimulus objects that will be compared against symbols to locate the most probable answers. The table includes the following fields:

Field: Name (a text string or a link to an external multimedia object, such as an image or sound).

Field: Query_Id: Link to ID field in the Query table.

The Decision Table 30 contains the list of possible answers for a given search and typically includes:

Field: Query_Id: Link to ID field in the Query table.

Field: Answer_Id: Link to the ID field in the Answer table.

The Learning Engine database schema 18 requires no additional tables. It acts upon and utilizes several existing tables (specified in the Teaching and Searching Engines) including:

The Stimulus Table 28

Used to identify which neurons need to be positively or negatively reinforced.

The Neuron Table 24

Positively or negatively reinforced, depending upon feedback from the searcher.

The Query Table 26

The given query is removed from the Query Table after the query has been resolved (feedback has been received or sufficient time has passed to assume that it won't be received.)

The Decision Table 30

The given query is removed from the Query Table after the query has been resolved (feedback has been received or sufficient time has passed to assume that it won't be received.)

The Teaching Engine logic 14 consists of one or more steps or acts required to accept a new answer and create or link between the symbols, answers and neurons required by the Searching and Learning Engines. The acts are as follows:

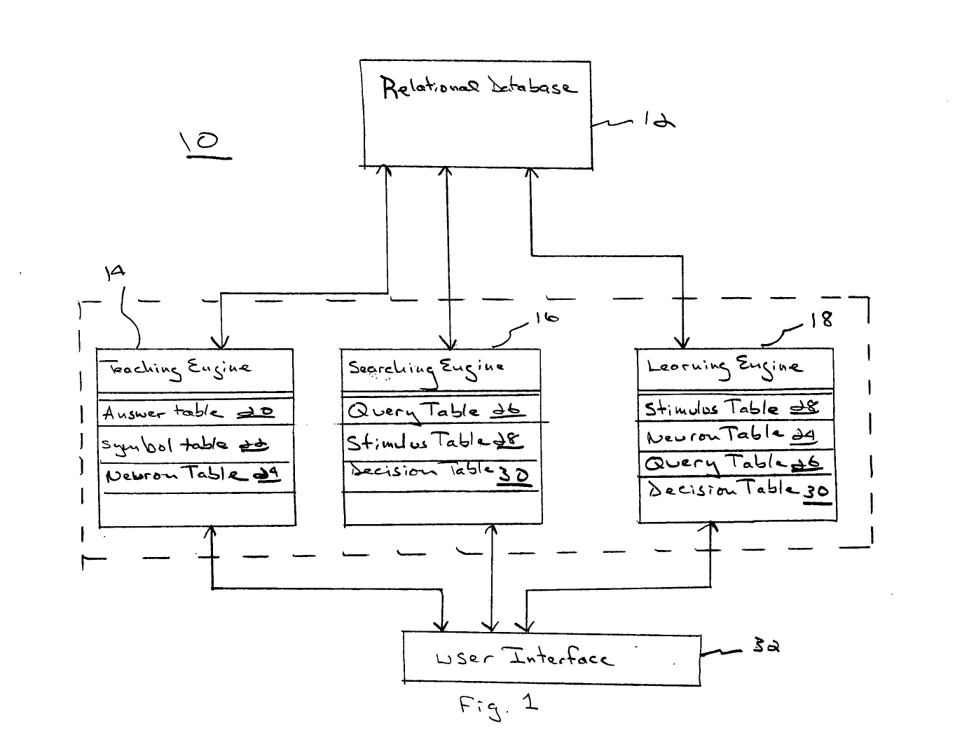

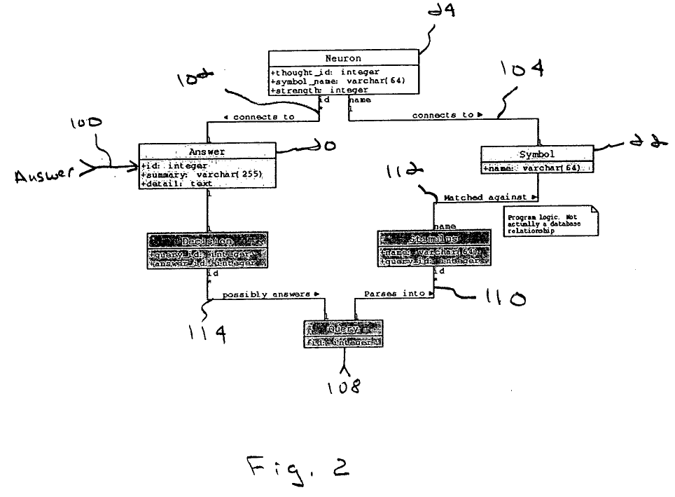

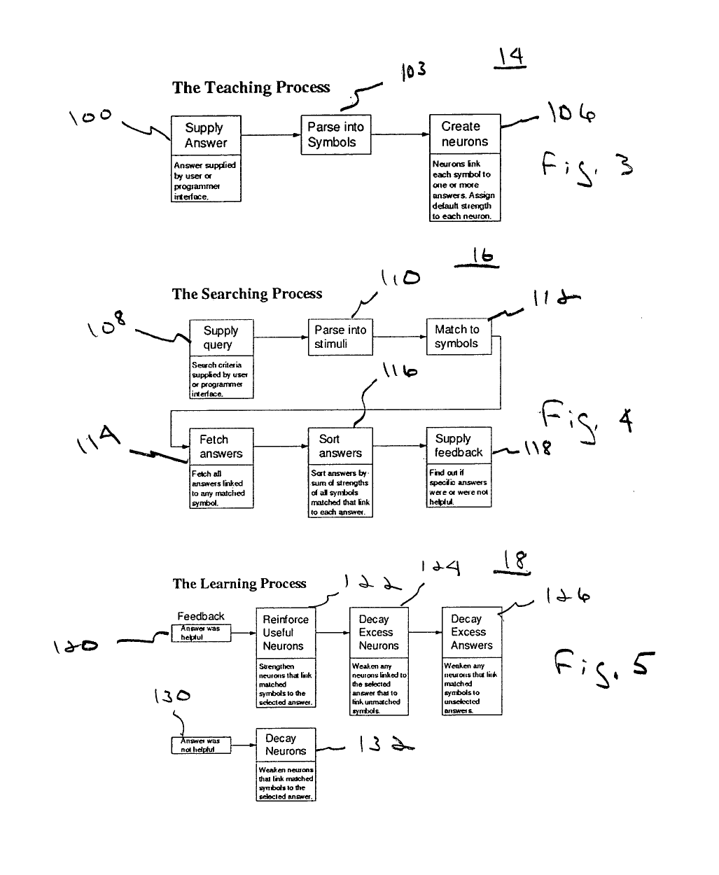

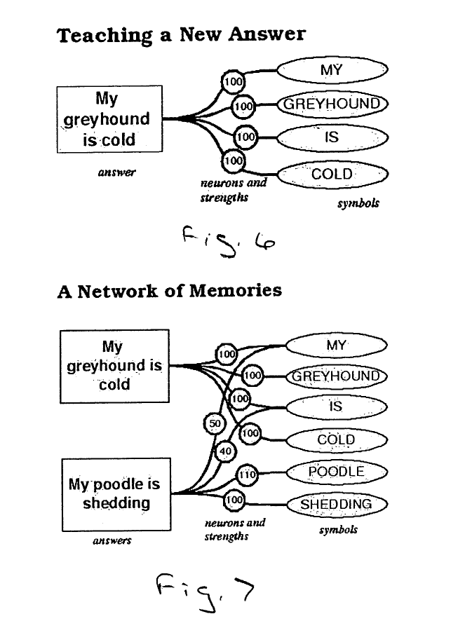

A. The answer (Summary and Detail) is supplied by a user or programmer interface (hereafter referred to as “the agent”) 32 and is added to the Answer Table 20, act 100, FIGS. 2 and 3. A unique ID is generated, act 102, for the ID field in the Answer Table.

The Summary (and optionally, the Detail) is parsed into symbols using the following rules: (1) All non-alphanumeric characters are converted to “space” characters (or some other non-alphanumeric character). Depending on the locale, non-alphanumeric characters that are generally considered part of a word (e.g., in English, the apostrophe) and are generally not converted. (2) Each space-delimited character-grouping is converted to upper case and is termed a “symbol”, act 103.

Each “symbol” generated above that does not exist in the Symbol Table is added to the Symbol Table, act 104.

An entry is created in the Neuron Table that links the name of each existing or newly-added symbol in the symbol table to the ID of the newly-added answer, act 106. The neuron strength is set to a default value.

The Searching Engine logic 16 consists of certain acts required to accept query, to create the required temporary search structures, to provide a list of possible answers, to display the specific answers when they are selected, and to solicit feedback about the usefulness of each selected answer, see FIG. 4. The acts are as follows:

The search text is supplied by the agent and is assigned an ID and added to the Query Table, act 108.

The search text is parsed into stimuli in exactly the same manner that answers are parsed into symbols, act 110, as described in act 104 above. Each stimulus is added to the Stimulus Table and linked to the original query using the Query_Id field in the Stimulus Table.

Each Stimulus is compared against the the Symbol Table, act 112. If a matching symbol exists, all Answers linked to that symbol via a neuron are written into the Decision Table, thereby linking those answers to the original query, act 114.

Each answer written to the Decision Table (linked to the original query) is assigned a weight equal to the sum of the strengths of each neuron that matches one of the query's stimuli. The answer summaries (i.e., the Decision List) are sorted and presented to the agent in order of descending strength, act 116.

When the agent selects an answer from the decision list, the full answer detail is displayed. The agent is then given the opportunity to provide feedback stating whether or not the displayed answer was relevant. This step is repeated for each answer the agent selects from the decision list, act 118.

The Learning Engine logic 18 includes those acts required to positively and negatively reinforce neurons after an answer has been selected by an agent and feedback has been provided, FIG. 5. The acts include:

If the agent specifies that a specific answer was useful to them, act 120:

A. The strength of each neuron linking that answer to a symbol that matches a stimulus from the original query is increased (positively reinforced) by a predetermined value, act 122. The amount it is increased may be a constant default value (such as 10) or it may be relative to the average neural strength in the system (such as 1.2 multiplied by the average).

B. The strength of each neuron linking that answer to a symbol that does not match any stimulus from the original query is decreased (negatively reinforced) by a predetermined value, act 124. The value used for negative reinforcement will generally be a small fraction of the value used for positive reinforcement.

C. The strength of each neuron linking an unselected answer to a symbol that matches a stimulus from the original query is decreased (negatively reinforced) by a predetermined value, act 126.

If the user or programmer interface states that a specific answer was not useful to them, act 130, each neuron linked to the selected answer and also to a symbol that matches a stimulus from the original query has its strength decreased (negatively reinforced) by a predetermined value, act 132.

A typical SONM system will have an optimal strengthening-to-weakening ratio that may be determined by observing the system in action. This ratio is optimal when both the average and maximum neural strength values stabilize and do not change significantly over time.

Several additions can be used to extend the base functionality of the disclosed embodiment of the present invention. First, the values for positive and negative reinforcement can be determined statistically, based upon reinforcement history and the current average values of the affected and unaffected neurons. Dynamic, statistically-generated values for positive and negative reinforcement will create a self-optimizing feedback loop, more effectively differentiating between useful and less useful neurons.

Second, several additional types of neurons can be introduced. In the base embodiment, neurons are used to relate symbols and answers. Similar logic can be employed to relate symbols to other symbols, allowing the search to account for the proximity of symbols to each other, and to relate answers to other answers, identifying answers that are similar or related to the selected answer.

Example of adding a new answer using the Teaching Engine:

It is desired to add an answer to the database describing what to do if your greyhound is cold. The answer consists of two parts: the question being answered, or summary, and the actual answer to the question, or detail. Note: To simplify the example, we will use only the summary for the initial teaching, although it is often preferable to include the detail as well.

Summary: “My greyhound is cold.”

Detail: “Put a coat on your dog.”

The summary and detail are added to the database and the resulting answer is assigned a unique identification. The summary is then broken into discrete symbols.

Answer ID: #1

Symbol
MY
GREYHOUND
IS
COLD

Each symbol is then linked to the answer by a neuron. The neuron contains a reference to the answer, a reference to the symbol, and a number representing the strength of the relationship between them. (See 24, FIG. 2).

TABLE 2
Neurons:

| Answer ID | Symbol | Strength |
|---|---|---|
| #1 | MY | 100 |
| #1 | GREYHOUND | 100 |
| #1 | IS | 100 |
| #1 | COLD | 100 |

Summarizing:

Each symbol must be unique (I.e., there may be only one instance of the symbol “GREYHOUND” in the system. Any number of neurons can refer to a specific symbol.

Each answer may or may not be unique. Any number of neurons can refer to a specific answer. See FIG. 7.

Each neuron must be unique; a specific answer may be linked to a specific symbol by one and only one neuron. See FIG. 7.

Example of searching for an answer using the Searching Engine:

A user would like to find out what to do if his or her dog is cold. He enters search using one of the system interfaces:

Query: “My dog is cold.”

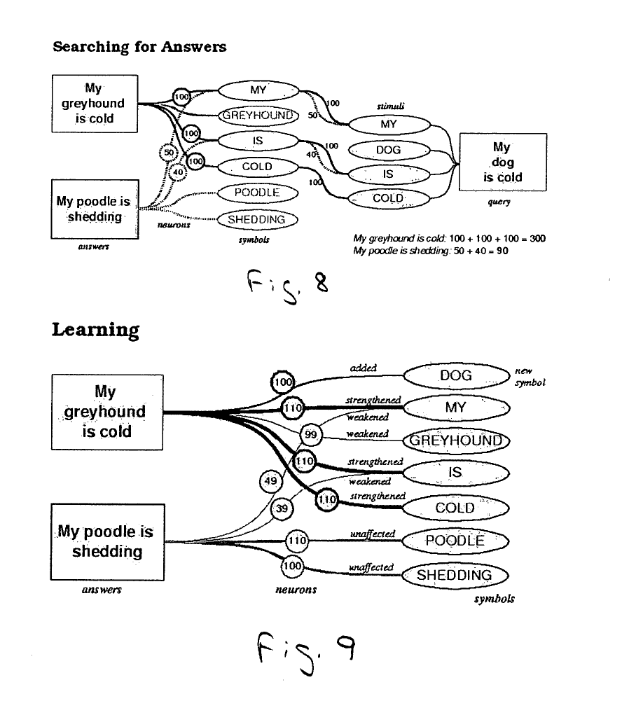

The query is parsed into stimuli in exactly the same manner in which an answer is broken into symbols, except that stimuli are linked directly to the query; no neurons are involved. See FIG. 8.

TABLE 3
Stimuli:
Stimuli
MY
DOG
IS
COLD

Each stimulus is checked against the symbols list. If there is a symbol that matches the stimulus, every answer linked to that symbol is added to a decision list as a possible solution. In this example, the stimuli MY, IS, and COLD match symbols linked to the above answer, so that answer is added to the decision list. See FIG. 8.

When all the stimuli have been checked, each answer in the decision list is assigned a weight equal to the sum of the strengths of all the neurons that link that answer with a symbol that matches one of the stimuli. If the neurons linking MY, IS, and COLD with thought #1 each have a strength of 100 (the actual assignment and adjustment of neuron strengths is discussed herein), the overall weight of that particular decision in the list is 300. The user is then presented with a list of answer summaries, sorted in descending order of weight.

Example of learning from an answer using the Learning Engine:

If a specific answer is selected from the decision list and validated as having been useful (see FIG. 9):

A. All neurons linking the selected answer to symbols that match stimuli are strengthened by increasing their strength value. The amount they are strengthened may be a constant default value (such as 10) or may be relative to the average neural strength in the system (such as 1.2 multiplied by the average).

B. All stimuli that do not already exist as symbols, are added as symbols and linked, via new neurons, to the selected answer. Each newly created neuron is assigned the default strength.

C. All neurons linking the selected answer to symbols that do not match stimuli are weakened by decreasing their strength value. The amount they are weakened is generally a small fraction of the strengthening value described in item 1, above.

D. All neurons linking the unselected answers to symbols that match stimuli are weakened.

A typical system consructed in accordance with the teachings of the present invention will have an optimal strengthening-to-weakening ratio that may be determined by observing the system in action. This ratio is optimal when both the average and maximum neural strength values stabilize and do not change significantly over time.

As a result of these changes, the system of the present invention learns to associate new search terms (symbols) with answers based upon stimuli present in the questions asked. In the previous example, the stimulus “dog” has now been added as a symbol and linked to this answer. Future searches that include “dog” as a stimulus will result in this answer being presented in the decision list. Further, stimuli that are frequently helpful in a particular search become more likely to impact the decisions listed in the future, while stimuli that are less helpful become less likely to impact the decisions listed.

One benefit of the present invention is a technology that is extremely inexpensive to implement and use, and that becomes more useful as agents use it to create, access, and apply information.

In general, the present invention has many advantages over existing solutions:

A. It is simple to build a system based upon this technology. The underlying structure and logic are fundamentally simple and easy to implement.

B. It is simple to add new knowledge to the database, ensuring that information can be easily collected when it is most relevant. No special formatting or organization of the knowledge is required, meaning little or no special training is required in order to contribute knowledge.

C. It is simple to locate and change knowledge in the database, ensuring that information can be kept up-to-date. A particular knowledge item can be located by unique ID, or it can be located using the search portion of the invention.

D. It is simple to remove dated or obsolete knowledge, ensuring that obsolete information does not become confused with current information. Dated or obsolete knowledge can be located by unique ID, or it can be located using the search engine portion of the invention. In addition, little-used knowledge will inherently have very weak neurons (see FIG. 5) and can be easily identified using basic database reporting techniques.

E. It is simple to search for knowledge without the need for a quoted or Boolean syntax. The invention optimizes the search automatically, and uses the results of previous searches to learn how agents are likely to word future searches.

F. Search effectiveness can be optimized for specific applications by adjusting the algorithms used for strengthening and weakening memories.

G. Teaching engine does not require a specific interface; knowledge can be added by people in response to what they know, or by automated systems in response to events in their environment.

H. Searching/Learning engine does not require a specific interface; knowledge can be searched for by people in response to a question or problem, or by automated systems in response to events in their environment.

Modifications and substitutions by one of ordinary skill in the art are considered to be within the scope of the present invention, which is not to be limited except by the following claims.

The invention claimed is:

1. A system for dynamically relating unstructured requests for information to at least one relevant answer, comprising:
a user interface, for receiving requests for information;
an answer table containing a plurality of answers to possible requests for information, each said plurality of answers including at least one character grouping;
a symbol table containing a plurality of unique symbols, each said plurality of unique symbols corresponding to one of said at least one character grouping of one answer in said answer table;
a neuron table including a plurality of weightable links each said weightable link corresponding to a weightable link between one of said plurality of unique symbols in said symbol table and one or more of said answers in said answer table;
a search engine, responsive to said user interface and to a received request for information, for parsing said received request into one or more query stimuli, for searching said symbol table for one or more unique symbols matching at least one of said one or more query stimuli, responsive to one or more matching unique answer symbols, for searching said neuron table to determine an answer responsiveness weight based upon individual answer symbol weightable links obtained from said neuron table for each of said one or more answers in said answer table having a weightable link between one of said plurality of unique symbols in said symbol table, and for presenting to said user one or more possible answers to said requested information based upon said determined answer responsiveness weight.

2. The system of claim 1 wherein said user interface receives answer feedback; and
further including a learning engine, responsive to said answer feedback, for increasing or decreasing said weightable link weight between unique symbols and said one or more answers.

3. The system of claim 2 wherein said learning engine strengthens one or more weightable links that match unique symbols to one specific answer.

4. The system of claim 2 wherein said learning engines weakens said weightable links.

5. The system of claim 2 wherein said learning engine weakens weightable links that match unique symbols to one or more non-selected answers.

6. A system for dynamically relating unstructured requests for information to at least one relevant answer, comprising:
a user interface, for receiving requests for information and for receiving answer feedback information;
an answer table containing a plurality of answers to possible requests for information, each said plurality of answers including at least one character grouping;
a symbol table containing a plurality of unique symbols, each said plurality of unique symbols corresponding to one of said at least one character grouping of one answer in said answer table;
a neuron table including a plurality of weightable links each said weightable link corresponding to a weightable link between one of said plurality of unique symbols in said symbol table and one or more of said answers in said answer table;
a search engine, responsive to said user interface and to a received request for information, for parsing said received request into one or more query stimuli, for searching said symbol table for one or more unique symbols matching at least one of said one or more query stimuli, responsive to one or more matching unique answer symbols, for searching said neuron table to determine an answer responsiveness weight based upon individual answer symbol weightable links obtained from said neuron table for each of said one or more answers in said answer table having a weightable link between one of said plurality of unique symbols in said symbol table, and for presenting to said user one or more possible answers to said requested information based upon said determined answer responsiveness weight; and
a learning engine, response to said answer feedback information, for increasing or decreasing a weight of said weightable link in said neuron table between a unique symbol and at least one specific answer.

7. A method for dynamically relating unstructured requests for information to at least one relevant answer, comprising the acts of:
providing a user interface, for receiving requests for information;
providing an answer table containing a plurality of answers to possible requests for information, each said plurality of answers including at least one character grouping;
providing a symbol table containing a plurality of unique symbols, each said plurality of unique symbols corresponding to one of said at least one character grouping of one answer in said answer table;
providing a neuron table including a plurality of weightable links, each said weightable link corresponding to a weightable link between one of said plurality of unique symbols in said symbol table and one or more of said answers in said answer table; and
providing a search engine, responsive to said user interface and to a received request for information, for parsing said received request into one or more query stimuli, for searching said symbol table for one or more unique symbols matching at least one of said one or more query stimuli, responsive to one or more matching unique answer symbols, for searching said neuron table to determine an answer responsiveness weight based upon individual answer symbol weightable links obtained from said neuron table for each of said one or more answers in said answer table having a weightable link between one of said plurality of unique symbols in said symbol table, and for presenting to said user one or more possible answers to said requested information based upon said determined answer responsiveness weight.

8. The method of claim 7 wherein said act of providing said user interface includes receiving answer feedback by said user interface; and
further including the act of providing a learning engine, response to said answer feedback information, for increasing or decreasing a weight of said weightable link in said neuron table between a unique symbol and at least one specific answer.

9. The method of claim 8 wherein said learning engine strengthens one or more weightable links that match unique symbols to a selected answer.

10. The method of claim 8 wherein said learning engines weakens weightable links.

11. The method of claim 8 wherein said learning engine weakens weightable links that match unique symbols to one or more non-selected answers.

12. The method of claim 8 further including the act of learning new knowledge, said act of learning new knowledge comprising the acts of:
receiving new answer information, said new answer information containing at least one character grouping;
adding said new answer information to said answer table;
parsing said at least one character grouping of said new answer information into at least one unique symbol;
adding said unique symbol to said symbol table if said unique symbol is not already in said symbol table and generating a new weightable link between said unique symbol and said new answer information; and
generating a new weightable link between a previously existing unique symbol and said new answer information if said unique symbol is already in said symbol table.

13. A method for adding new answer information and for dynamically relating unstructured requests for information to at least one relevant answer to an answer retrieval system, said method comprising the acts of:
providing a user interface, for receiving new answer information and requests for information;
providing an answer table containing a plurality of answers to possible requests for information, each said plurality of answers including at least one character grouping;
providing a symbol table containing a plurality of unique symbols, each said plurality of unique symbols corresponding to one of said at least one character grouping of one answer in said answer table;
providing a neuron table including a plurality of weightable links , each said weightable link corresponding to a weightable link between one of said plurality of unique symbols in said symbol table and one or more of said answers in said answer table;
receiving new answer information, said new answer information containing at least one character grouping;
adding said new answer information to said answer table;
parsing said at least one character grouping of said new answer information into at least one unique symbol;
adding said unique symbol to said symbol table if said unique symbol is not already in said symbol table and generating a new weightable link between said unique symbol and said new answer information;
generating a new weightable link between a previously existing unique symbol and said new answer information if said unique symbol is already in said symbol table; and
providing a search engine, responsive to said user interface and to a received request for information, for parsing said received request into one or more query stimuli, for searching said symbol table for one or more unique symbols matching at least one of said one or more query stimuli, responsive to one or more matching unique answer symbols, for searching said neuron table to determine an answer responsiveness weight based upon individual answer symbol weightable links obtained from said neuron table for each of said one or more answers in said answer table having a weightable link between one of said plurality of unique symbols in said symbol table, and for presenting to said user one or more possible answers to said requested information based upon said determined answer responsiveness weight
